(19) United States
(12) Patent Application Publication
(10) Pub. No.: US 2024/0191775 A1
(43) Pub. Date: Jun. 13, 2024

(54) ENERGY CHAIN WITH ITS OWN ENERGY SOURCE AND CHAIN LINK FOR SAME

(71) Applicant: IGUS GMBH, Koeln (DE)

(72) Inventor: Richard HABERING, Köln (DE)

(21) Appl. No.: 18/554,070

(22) PCT Filed: Apr. 5, 2022
(86) PCT No.: PCT/EP2022/059015

§ 371 Date: Oct. 5, 2023

(30) Foreign Application Priority Data
Apr. 6, 2021 (DE) 20 2021 101 817.8

(51) Int. Cl. F16G 13/16; H02K 35/02

(52) U.S. Cl. CPC F16G 13/16; H02K 35/02

(57) ABSTRACT

An energy chain for guiding lines, such as cables, hoses or the like, between two connection points, at least one of which is movable relative to the other. The energy chain comprises chain links which are connected to each other and pivotable with respect to each other, wherein the energy chain is movable in particular with a first strand relative to a second strand while forming a deflection are between the strands and at least one load consuming electrical energy, which is arranged at or in the energy chain, in particular at least one sensor module at a chain link for detecting an operating parameter of the energy chain. The energy chain includes an energy converter which is designed to convert mechanical energy, in particular kinetic energy, of the energy chain into electrical energy when the energy chain, in particular the movable first strand and/or the deflection arc, is moved, and which is connected or connectable to the consumer load in order to supply the latter.

### FIELD

The invention relates generally to the field of movable line guides. In particular, it relates to an energy chain for dynamically guiding lines, such as cables, hoses or the like, and a chain link for same.

### BACKGROUND

Energy chains are used to protect lines between two connection points, at least one of which is movable or displaceable relative to the other. Energy chains typically consist of chain links which are articulated and/or pivotably connected to each other and which form a receiving space for the lines and can protect any type of flexible line, for example cables for electrical power and/or signal supply or hoses for the supply of liquid or gaseous operating media.

Energy chains are usually provided as components of industrial machines and systems for supplying moving machine or system components, for the protected guidance of at least one supply line, for example between a base or a fixed point and a driver movable relative thereto. They serve to protect the supply lines guided therein from damage due to kinking or overstressing during movement and possibly also external influences. Energy chains usually form a moving strand, a stationary strand and a deflection arc in-between, which travels at half the speed of the moving strand.

Energy chains of various designs are known. Sliding or rolling variants of energy chains, in which the moving upper strand slides or rolls on the stationary lower strand or a slide rail, are used in particular for relatively long travel distances, for example in harbor cranes. For shorter travel distances, self-supporting energy chains with a self-supporting moving strand are often used.

The guided lines, likewise in a wide variety of designs, are generally used to supply at least one movable external load (outside the energy chain) with power, data and/or media, usually starting from one or more supply sources at a typically stationary connection point.

In the course of the intelligent networking of machines and processes in industry with the help of information and communication technology (“Industry 4.0”) and the associated efforts striving for additional functionality and the optimization of processes, innovations are being implemented in many areas, especially in industrial production. One example of this is monitoring systems, especially wireless monitoring systems, which are integrated into previously unmonitored maintenance-prone components of, for example, production lines. In this context, it comprises already been proposed to extend an energy chain itself by at least one load of electrical energy used for monitoring, which is arranged at or in the energy chain.

Specifically, energy chains have already been proposed which have been expanded by corresponding sensor and communication modules that offer intelligent functions in the sense of Industry 4.0, in particular for monitoring operation and/or for determining maintenance intervals or for preventive maintenance.

WO 2018/115528 A1 describes examples of such monitoring systems for energy chains. Available on the market is, for example, the module offered under the trade name EC.M by the company igus GmbH, D-51147 Cologne. With this module for the initial fitting or retrofitting of energy chains, values such as acceleration, speed, temperature and other required data can be recorded, and can be used in particular for calculating the failure-free minimum running time or for predicting the service life, and can be transmitted wirelessly, as also described in WO 2018/115528 A1 (see there FIG. 6A-FIG. 9).

Such devices require electronics to realize the desired information and communication technology and must therefore be electrically fed or supplied with power.

A simple solution to this would be to feed power by an additional supply line that is laid within the energy chain.

It is also conceivable to have a separate energy store in the module, as proposed in WO 2018/115528 A1, in order to avoid a wired power supply. Batteries, for example, can be considered as energy stores.

The energy supply via supply lines makes retrofitting sensors in existing energy chain systems complex and is not possible under all circumstances, for example if the receiving space of the energy chain is already completely filled. Furthermore, such an additional supply line would also have to be renewed when it reaches its wear-related limited service life.

A power supply via energy store or battery is also relatively maintenance-intensive, as batteries have to be replaced at regular intervals. In addition to high material and labor costs, this can lead to undesirably long downtimes of the system or machine, especially in large systems with many energy chains and several modules each, i.e. it is impractical for applications with high availability.

### SUMMARY

A first object of the present invention is therefore to improve the power supply of such modules and sensors to the extent that the above-mentioned disadvantages are at least partially eliminated or to the extent that an uncomplicated retrofitting of already existing energy chain installations with information and communication technology, in particular with sensor technology for recording parameters or states or other IoT technology (Internet-of-Things), is made possible.

Energy chains are intended to guide lines to non-stationary, moving connection points. An energy chain is intended to be moved at least in some sections, in particular alternately back and forth. The movement is typically implemented by the machine or system part to be supplied, which is itself moved depending on the application.

The present invention is based in particular on the basic concept, which appears simple in retrospect, of utilizing mechanical energy, in particular kinetic energy, occurring as intended within the energy chain, in particular in the moving strand and/or in the deflection arc, in order to be able to supply a load at or in the energy chain.

Based on this knowledge, it is proposed in a generic energy chain, according to a first core aspect of the invention, that an energy converter is provided which is designed to utilize mechanical energy, in particular kinetic energy, of the energy chain, which is transferred to the energy chain during the intended movement of the energy chain, and to convert this mechanical or kinetic energy into electrical energy. The mechanical or kinetic energy is typically transferred to the energy chain from the moving part of the machine or system that is to be supplied.

The electrical energy thus generated at or in the energy chain itself can simply be used to supply the load provided at the energy chain depending on the application. This surprisingly simple approach makes it possible to generate electrical energy autonomously and as maintenance-free as possible, and to secure the electrical supply.

According to a core concept of the invention, the energy chain is thus designed or extended to generate electrical energy itself and to feed one or more loads with this energy, in particular loads which are arranged as “internal loads” so to speak in or at the energy chain or are arranged to travel with it. This eliminates the need to lay another supply line from one of the connection points to the load through the energy chain or the need to replace used batteries.

The energy converter can particularly preferably be designed to convert mechanical, in particular kinetic, energy into electrical energy. In principle, any suitable electromechanical energy converter can be used for this purpose. However, this is not mandatory, for example another converter principle can also be used as a supplement or alternative, for example solar cells.

However, electromechanical energy converters are particularly preferred, wherein various principles known per se can be used on the energy chain, for example rotary generators for converting rotary motion, particularly in the case of rolling roller chains, linear generators for utilizing the travel motion in the longitudinal direction, a shake generator or vibration converter or similar so-called energy harvesters, etc. Piezoelectric converters are also conceivable.

According to a further aspect of the invention, a single chain link can thus be equipped in accordance with the invention such that it includes an energy converter which is designed to provide electrical energy which can be used to supply a load at or in the energy chain, i.e. possibly also at or in another chain link.

In the following, the word “device” for short means either an energy chain or a chain link, wherein the majority of the mentioned features then apply equally to both. The term “moving strand” means the length portion of the energy chain that is moved as intended and is of variable length depending on the travel distance or the momentary position during the movement. The term “stationary” or “still” strand means the length portion of the energy chain in the momentary view which is still in relation to the moving strand. In principle, however, depending on the application, both ends or strands of the chain can also be moved. The deflection arc refers to the travelling or moving transition between the strands in which the pivotable chain links are deflected while maintaining the predetermined minimum radius to protect the cables.

In one embodiment, the energy chain can include at least one sensor module as a load for implementing predictive maintenance or avoiding failures. In particular, the sensor module can be designed to detect at least one operating parameter, such as the distance travelled so far or number of travel cycles, the movement speed, temperature, etc. Preferably, at least one sensor module is designed for wireless communication with a higher-level monitoring system, such as a cloud system or the like. Such a monitoring system can determine or calculate an expected remaining service life of the energy chain and/or the individual chain link from transmitted operating parameters in order to enable predictive or anticipatory maintenance and to optimize the use of the service life.

If a wirelessly communicating sensor module is supplied with electrical energy by the energy converter, the sensor module can be operated completely autonomously and maintenance-free. In particular, the energy converter can supply the load, for example the sensor module, with interruptions, for example only when the energy chain is moving, or largely without interruptions, for example via a capacitor or accumulator connected to the sensor module and charged via the energy converter.

In conjunction with wirelessly communicating sensor modules, the invention is particularly advantageous, since neither maintenance-prone supply lines nor batteries to be replaced are necessary and, in particular, the intensity of the usable mechanical or kinetic energy inherently increases with the wear of the energy chain due to movement wear. Reliability of the energy supply in critical applications is then inherent.

A particularly advantageous embodiment for rolling energy chains for long travel distances is that the energy converter is designed in the form of a rotary generator based on the principle of electromagnetic induction. The rotary generator is operatively connected to or arranged at an associated track roller and can use the rotary movement or rotational energy of the track roller. The rotary generator preferably comprises an induction winding which is fixed to the chain link and with which at least one excitation magnet on the track roller interacts. For this purpose, a plurality of permanent magnets can preferably be integrated into the track roller and can interact with at least one induction coil attached to the side plate of the chain link. With suitable side plates with roller chains, this design also allows, among other things, retrofitting by replacing the roller and mounting a coil unit. This solution can be realized compactly and robustly and allows a relatively high energy yield.

Preferably, a plurality of permanent magnets are distributed equally over the circumference of the carrying wheel, preferably an even number with alternating pole directions in the circumferential direction and/or at the outside of the circumference. As an alternative to individual distributed magnets, for example a round magnet with different pole regions can also be used as a rotor, but distributed individual magnets save weight and can possibly be integrated or retrofitted more easily in existing track rollers.

Alternatively, however, the excitation magnets at the side plate and/or induction coil(s) at the carrying wheel can also be provided in the rotary generator. It is also conceivable to use electromagnets instead of or in addition to permanent magnets, possibly also using the dynamo-electric principle.

Sensors for measuring operating parameters can also be integrated into such a rotary generator. The distance travelled by the track roller assigned to the rotary generator can be determined, for example in the form of the rotational speed, and transmitted wirelessly to at least one processing electronics unit. A measurement of the power generated so far by the rotary generator also provides valuable information, because this is directly dependent on the travelled distance of the particular roller chain link and can thus also be used to estimate a remaining service life of the energy chain or its parts.

Another embodiment of the device according to the invention—which is also suitable, for example, for unsupported energy chains—provides for an electrical generator, in particular according to the principle of an electrical linear generator, to interact with a number of magnets distributed along the chain length. For this purpose, an effective conversion of kinetic energy of the energy chain into electrical energy can be achieved in particular during the movement by the magnets in the induction coil of the energy converter. The magnets can form a linear generator with the winding(s) of the energy converter. For this purpose, a number of magnets, preferably permanent magnets, can be provided as a stator, for example at least at a longitudinal portion of the energy chain, in particular in the longitudinal half towards the fixed point of the stationary strand. Alternatively or additionally, a number of permanent and/or electromagnets can be provided at a support arranged laterally to the energy chain, such as a side wall of a guide channel. To increase the energy yield, a plurality of energy converter units with respective induction windings can also be arranged distributed along the chain length, preferably in the region of the first third of the chain at the driver side, which typically performs the longest movement strokes.

In principle, solutions are advantageous which effect the conversion of the mechanical or kinetic energy as wear-free and contact-free as possible via an induction coil, so that the energy converter itself can be operated with little or no maintenance.

In one embodiment of the device according to the invention, the sensor module may include at least one integrated induction coil for generating power by electromagnetic induction. Such an integrated design can ensure easy installation and uncomplicated retrofitting into existing energy chain installations, because only the permanent magnets and the at least one sensor module need to be attached to an energy chain, without the need for additional wiring.

In an embodiment with permanent magnets attached to the energy chain, each permanent magnet can be provided on every n-th chain link, in particular on the crossbar or separating bar of a chain link of the energy chain. The arrangement of the permanent magnets at the outer side of a crossbar facing the other strand is particularly efficient for minimizing the distance between the permanent magnets and the induction coil and for increasing the magnetic flux. To further increase the energy yield, the permanent magnets can preferably be arranged in the region of the last third of the stationary strand at the driver side, so that the energy converter crosses the permanent magnets as often as possible. The induction coil is preferably also attached here to one or more crossbars, preferably outside the receiving space for the lines, for example with a coil axis perpendicular to the longitudinal direction and parallel to the side plates.

Alternatively or additionally, the energy converter can comprise a vibration energy converter or a type of shake generator, which converts the motion energy of the moving strand. In this case, the energy converter can be attached, for example, to a moving end region of the first strand at the driver side. An advantage of a vibration energy converter is that comparatively compact and inexpensive designs are available on the market, which may also be easy to retrofit, for example if integrated into a module. For example, the need for further elements such as permanent magnets, which would have to be attached separately, can be avoided, which considerably reduces the material costs, but also the installation and retrofitting effort. In particular, the vibration energy converter can be comparatively small, for example as a so-called energy harvester, and possibly also micromechanical.

In an advantageous embodiment with vibration energy converter, this vibration energy converter has at least one induction coil and at least one permanent magnet as an exciter which is supported by a bearing unit so as to be able to vibrate freely. The bearing unit can in particular comprise at least one spring element for the resilient mounting of the permanent magnet. The permanent magnet can be, for example, a bar magnet mounted with play in a tubular guide. With the vibration energy converter, by reciprocating movement of the energy chain, for example an oscillation of the permanent magnet in the longitudinal direction of the energy chain or perpendicularly thereto can be generated to create a variable magnetic field within the induction coil, which induces voltage.

Combinations of a mechanical drive device with a flywheel mass, similarly to a wristwatch mechanism, which drives a compact rotary generator, are also conceivable as a converter, so that power can be generated comparatively constantly, also between the driving cycles. In particular, the flywheel mass can be mounted in such a way that it is actuated or deflected again each time the chain link pivots in the deflection arc.

In another embodiment of the device according to the invention, the energy converter can comprise a piezoelectric component which is provided for generating voltage from mechanical pressure. The piezo component can be arranged, for example, between interacting stops of adjacent chain links.

In one embodiment of the energy converter, this can alternatively or preferably in addition to already mentioned embodiments, such as the vibration energy converter, comprise a solar cell for generating electrical energy, so that electrical energy can be generated by the solar cell even during a standstill of the energy chain.

In an advantageous embodiment, an energy converter can thus be in the form of a solar cell attached to a chain link of the energy chain or to a sensor module.

In another embodiment, it can be advantageous to provide energy converters only in the form of solar cells, so that no conversion of kinetic energy into electrical energy takes place. This can be advantageous, for example, in installation environments in which a particularly low weight of the energy chain is required, so that a motion energy converter would be disadvantageous due to its own weight caused by permanent magnets and other electromechanical components, and if, for example, in applications in which no magnetic elements may be used, so that the use of an induction generator is not possible.

A further advantageous embodiment of the device according to the invention can include an electrical energy storage unit, in particular an accumulator or capacitor storage unit, to store power generated discontinuously by the energy converter for supplying the load or a load as required.

One embodiment of the device according to the invention provides a sensor module for detecting an operating parameter of the energy chain, which parameter is connected to the energy converter for the power supply and/or in which the energy converter for the power supply is integrated, wherein the sensor module preferably comprises the energy storage unit and this is connected to the energy converter via a charging circuit. Such integral designs can ensure that the installation effort is considerably reduced.

A further advantageous embodiment of the device according to the invention provides that the sensor module is supplied exclusively by the one or more energy converters and interacts wirelessly with a monitoring system and/or wirelessly with a portable terminal, wherein the sensor module preferably comprises at least one acceleration sensor, one temperature sensor and one radio data transmission unit, wherein the radio data transmission can take place in particular via Bluetooth, Wi-Fi or mobile data network such as LTE.

### BRIEF DESCRIPTION OF THE DRAWINGS

Further advantageous features and effects of the invention are explained in more detail below on the basis of some preferred exemplary embodiments with reference to the accompanying drawings, in which:

FIGS. 1A and 1B show a sketched cross-section of an exemplary embodiment of an energy chain according to the invention, which includes an energy converter, wherein FIG. 1A shows a self-supporting movable strand and FIG. 1B shows a sliding movable strand;

FIG. 1C shows a principle diagram of an exemplary embodiment of an energy converter with integrated induction coil and integrated sensor used with the energy chain according to the invention;

FIG. 1D shows a perspective view of a chain link of an exemplary embodiment with two permanent magnets attached to a crossbar;

FIG. 2 shows a schematic longitudinal section of an exemplary embodiment of an energy chain according to the invention with a self-supporting upper strand;

FIG. 3A shows a cross-section of an exemplary embodiment with a vibration energy converter, an auxiliary module and a sensor module;

FIG. 3B shows a principle diagram of a vibration energy converter as shown in FIG. 3A;

FIG. 4 shows a longitudinal section of two chain links connected by way of an articulated joint with energy converter in the form of a piezo element;

FIG. 5A-5B: show two particularly preferred exemplary embodiments with a side plate of a roller chain link of a roller chain with rotary generator as energy converter, in cross-section (FIG. 5A) and in perspective view (FIG. 5B) from the inside; and

FIG. 6 shows a schematic diagram of an energy chain according to the invention, which includes energy converters in the form of solar cells.

### DETAILED DESCRIPTION

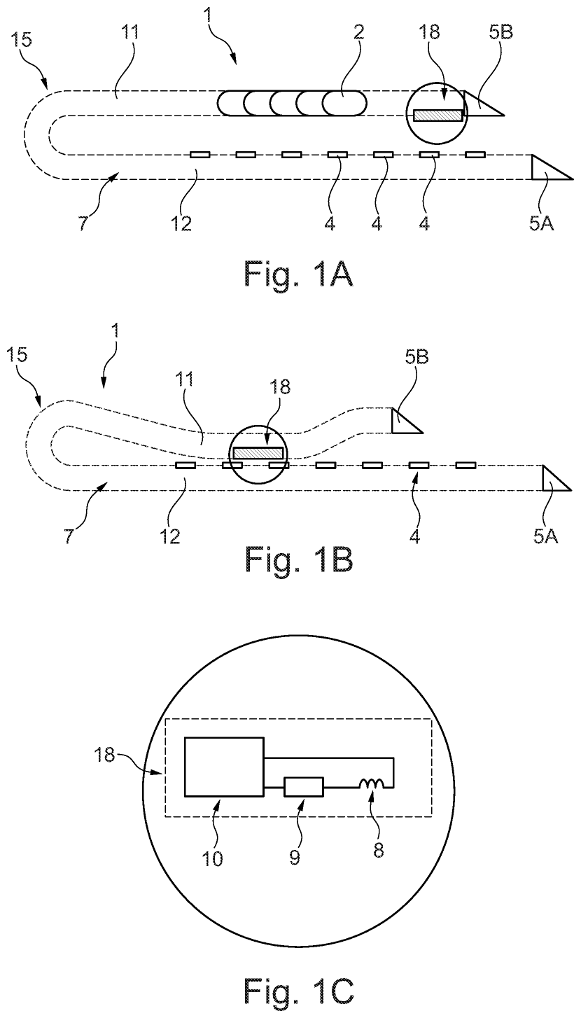

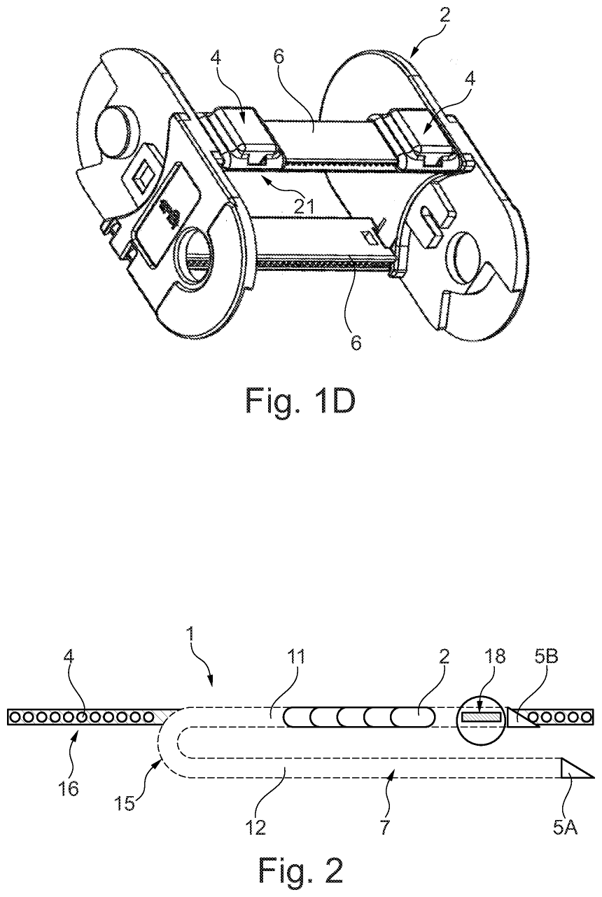

In FIG. 1-6, an energy chain is shown only schematically and is generally denoted by 1. The energy chain 1 comprises chain links 2 which are pivotable relative to each other in a plane and which can have a construction known per se. In operation, the energy chain 1 can be divided into a movable strand 11 and a still or stationary strand 12. The strands 11, 12 have variable lengths depending on the travel position and are connected by a deflection arc 15, which changes its position as the moving strand 11 moves. Furthermore, the energy chain 1 is composed of a plurality of individual chain links 2 which are movably connected to each other and provide a receiving space 7. The last chain links 2 of the energy chain 1 in the longitudinal direction each have end fastenings 5A, 5B, namely a stationary end fastening 5A (fixed point) for fastening the stationary strand 12 to a machine or system and a driver-side end fastening 5B for fastening the movable strand 11 to the driver of the relatively movable part of the machine or system that is to be supplied. The figures show a horizontally movable energy chain 1, but this could also be arranged differently, for example vertically suspended.

In the example shown in FIG. 1A-1D and FIG. 2, the energy chain 1 in each case comprises its own electrical generator as an energy converter 18. The energy chain 1 comprises a self-supporting movable strand 11 (FIG. 1A, FIG. 2), or a sliding or rolling strand 11 (FIG. 1B).

Permanent magnets 4 and/or electromagnets are provided at a number of the chain links 2 of the stationary strand 12 as excitation magnets for generating power by electromagnetic induction by means of an induction winding or induction coil 8 of the energy converter 18. In FIG. 1A-1D and FIG. 2, the permanent magnets 4 form a linear electrical induction generator with the energy converter 18. The position of the energy converter 18 comprising at least one induction coil within the movable strand is only indicated by way of example in FIGS. 1A and 1B and should always be selected depending on the travel distance, for example in the region of the first third of the energy chain on the driver side, close to the driver 5B. In this way, the energy converter 18 can traverse the magnetic fields of the permanent magnets 4 as frequently as possible in order to maximize the number of magnetic field changes, i.e. the energy yield.

FIG. 1B describes a further embodiment of the energy chain 1 according to the invention as shown in FIG. 1A. The essential difference to the embodiment shown in FIG. 1A is that the movable strand 11 rests on and slides over the stationary strand 12, i.e. the distance between induction coil 8 and permanent magnets 4 is reduced.

FIG. 1C shows an energy-autonomous assembly as it can be used in the embodiment of the energy chain according to the invention shown in FIGS. 1A and 1B. This assembly is designed to extend an energy chain with additional functions, in particular IoT functions or sensor technology for recording status or operating parameters. For this purpose, a sensor module 10 is provided, which in particular determines operating parameters such as temperature or material conditions of the energy chain 1, for example the wear condition, and transmits them to a superordinate monitoring unit, in particular wirelessly. The induction coil 8 is connected to a conversion unit 9. The conversion unit 9 is equipped with rectifier electronics, smoothing electronics and the like for converting the power induced by the at least one induction coil 8 in order to feed the at least one sensor module 10 or an electrical energy store for supplying the sensor module 10.

In FIG. 1D, a chain link 2 according to WO 2018/115528 A1 is shown. The chain link 2 comprises two permanent magnets 4 attached to one of the non-detachably and/or detachably attached crossbars 6. In this case, the permanent magnets 4 can be subsequently attached to crossbars 6 by means of a magnetic holder 21, for example an injection-molded part, thus enabling a quick and easy installation. Similarly, the induction coil 8 can also be attached to the chain link by means of an appropriately dimensioned holder in the form of an injection-molded part (not shown).

Another embodiment of an energy chain 1 with energy converter 18 is shown in FIG. 2, with a self-supporting upper strand 11. The movable upper strand 11 of the energy chain 1 runs along a holder rail 16 in the longitudinal direction. The rail 16 comprises a plurality of permanent magnets 4 and/or electromagnets which interact with the energy converter 18 in the movable strand 11 thereof when the energy chain 1 is moved, whereby a voltage is induced in the induction coil 8 provided in the energy converter 18. A further embodiment provides for the use of a second, identical holder rail 16 on the opposite side. This increases the number of magnets 4 to achieve a higher magnetic flux.

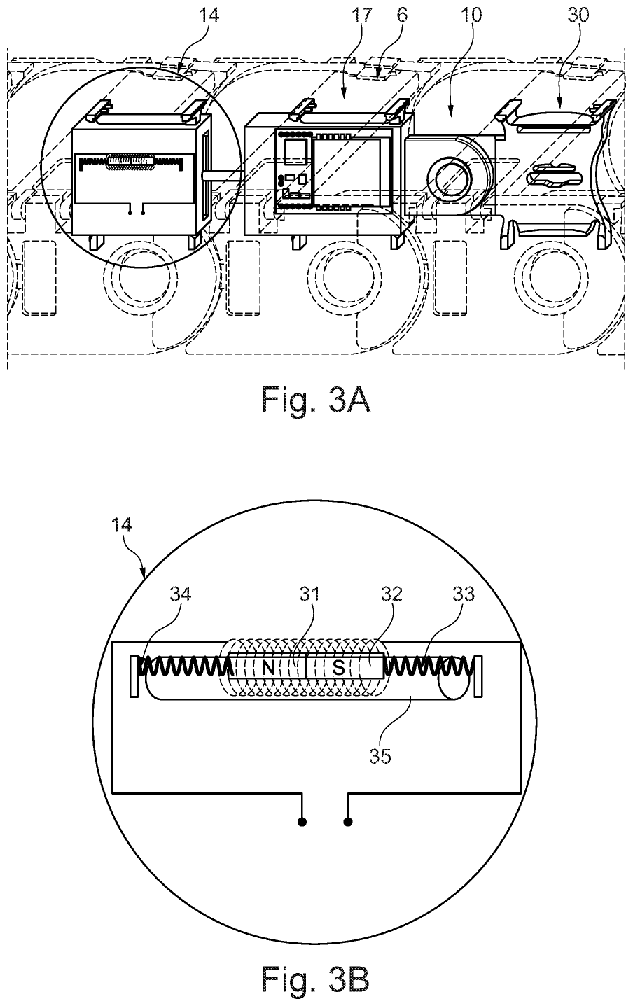

FIG. 3A shows a cross-section of an embodiment of an energy chain 1 according to the invention with an alternative energy converter in the form of a vibration energy converter 14 for supplying a sensor module 10, for example preferably via a rechargeable capacitor storage unit (not shown). The sensor module 10 of FIG. 3A detects wear in the link-pin connection between two selected chain links. The vibration energy converter 14 further supplies an auxiliary module 17 with at least one integrated circuit which, among other things, processes the data generated by the sensor module 10 and transmits it, preferably wirelessly, to a monitoring unit, for example via WLAN, Bluetooth, or the like. The vibration energy converter 14 and the modules 17 and 10 each have a crossbar receptacle 30 on an upper and lower side for fastening to the crossbars 6. The energy converter 14 and the modules 17 and 10 are fastened between the crossbars 6 in the receiving space 7 in a manner similar to separating bars known per se and are distributed here, for example, over three chain links, wherein a more compact design is also possible, for example a sensor module 10 with vibration energy converter 14, which is completely accommodated in a single chain link or is attached to its crossbar, for example.

An exemplary energy converter in the form of a vibration energy converter 14 is shown in FIG. 3B in a principle sketch. The vibration energy converter 14 comprises a permanent magnet 32, for example in the form of a strong neodymium bar magnet, two spiral springs 33 and an induction coil 31. The two spiral springs 33 for resetting are each fastened with one of their ends to a holding point 34 and the free end in each case is fastened to the bar magnet 32, so that the bar magnet 32 can oscillate as long as possible after a deflection comprises taken place between the two holding points 34 and within the induction coil 31. The bar magnet 32 is mounted in a tubular or hollow-cylindrical guide 35 so as to be axially displaceable without friction. This arrangement can be arranged with the guide axis of the bar magnet 32 or the hollow-cylindrical guide 35 in particular parallel to the direction of travel of the movable strand 11, as indicated in FIG. 3A, or perpendicular to the direction of travel of the movable strand 11.

In the vibration energy converter 14, the bar magnet 32 is caused to vibrate by the back and forth movement, by the deflection in the deflection arc 15 and/or by vibration or oscillations of the movable strand 11. The movement axis can be arranged here in such a way that the deflection of the chain link 2 in the deflection arc 15 leads to the oscillation of the bar magnet 32. The energy converter 14 should be provided at a longitudinal position of the energy chain 1 at which the chain link experiences movement as frequently as possible, for example in the middle region of the chain length. Alternatively, for example, the kinetic energy when moving back and forth in the longitudinal direction of the energy chain 1 can also be used close to the driver 5B, for example.

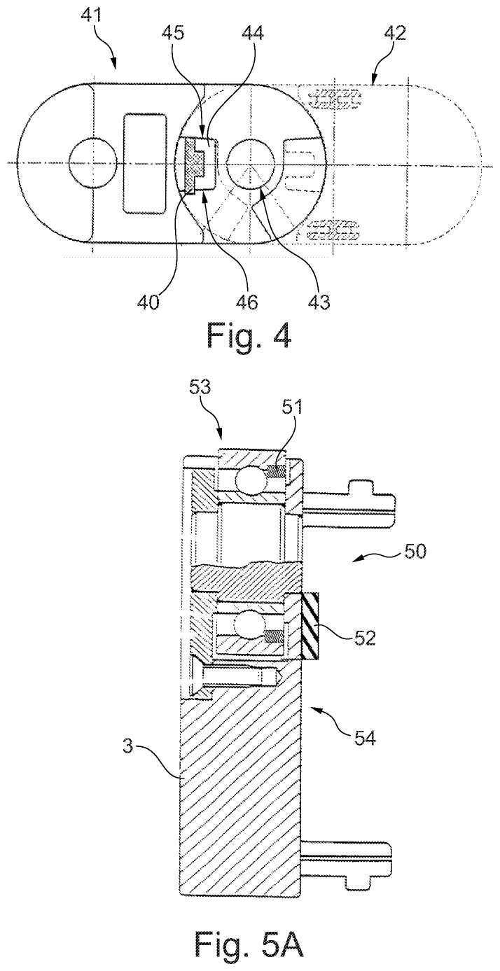

FIG. 4 schematically shows an embodiment of an energy converter integrated into the chain link connection according to DE29607492U1 of a first chain link 41 and a second chain link 42. The energy converter is formed by a deformable piezo element 40 inserted into a stop and projecting, for example, from an upper or lower stop surface 45, 46 of the stop 44. When the two chain links 41, 42 are swiveled towards each other into the stretched position, the piezo element 40 is subjected to pressure by the counter stop of the other chain link 41 through the upper or lower stop surface 45, 46, as a result of which tension is generated in the other chain link.

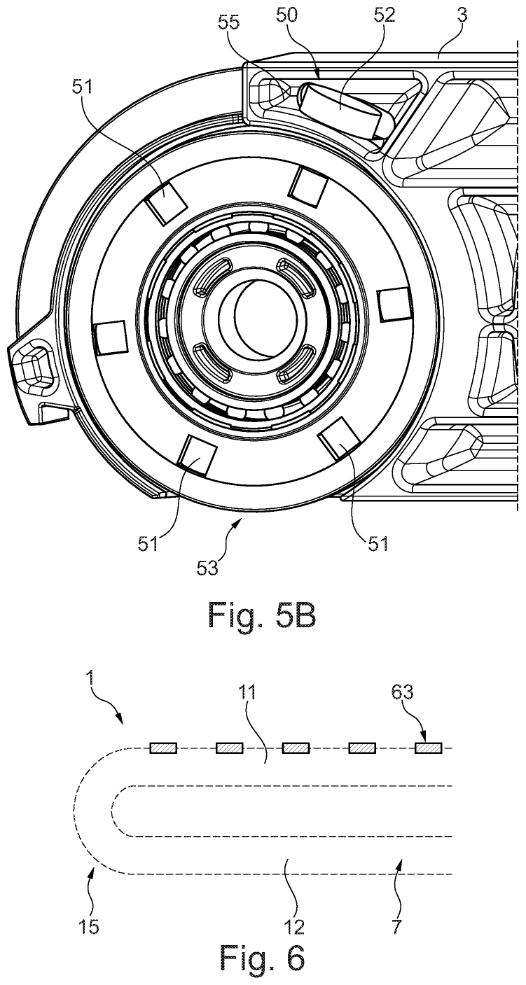

In FIG. 5A-5B a side plate 3 is shown in cross-section. This side plate corresponds to the principle of a chain link 2 of a rolling energy chain 1, which is particularly suitable for long travel distances. The chain link 2, in FIG. 5A for example according to WO 99/57457 A1, is composed of two opposite side plates 3 connected by two crossbars (detachable here, not shown). The movable strand 11 of an energy chain 1 according to WO 99/57457 A1 moves with track rollers 53 on a running surface on the narrow sides of the stationary lower strand of the stationary strand 12 in order to reduce the required tractive force or to increase the maximum usable length, i.e. to enable greater travel distances. The track rollers 53 are mounted here about an axis of rotation which lies in the lateral direction, in particular perpendicularly to the plane defined by the longitudinal direction of the energy chain 1 and the height direction of the side plate 2.

FIG. 5A-5B show a further development according to the invention of a rolling energy chain 1 or side plate 3 with track rollers 53. This further development provides for an energy converter in the form of a rotary generator 50, in this case with excitation magnets 51 at the track roller 53 and at least one induction coil 52 at the side plate 2—wherein another, for example inverted, arrangement is also conceivable. The rotary generator 50 generates power by utilizing the rotary movement of the track rollers 53. Unlike conventional dynamos, the rotary generator 50 does not comprise a rotary magnet, but a plurality of individual, strong permanent magnets distributed over the circumference of the track roller 53 as excitation magnets 51, for example neodymium magnets. The excitation magnets 51 are attached to the track roller 53, preferably in an even number with alternating pole directions. When the track roller 53 rotates, voltage is induced in the induction coil 52, which is energized by the rotating and possibly alternating magnetic field of the excitation magnets 51. Not shown are further typical circuit components of known design for the power supply, such as a circuit for rectifying and possibly smoothing the generated voltage or for feeding an energy store.

In the example from FIG. 5A, the induction coil 52 is mounted in the receiving space 7 of the chain link 2 at the inner surface 54 of the side plate 3. The excitation magnets 51 are oriented with their main direction of the magnetic field parallel to the axis of rotation of the track roller 53. In an advantageous embodiment, the induction coil 52 is provided in a prefabricated receptacle in the chain link 2 to reduce the distance between the excitation magnets 51 and the induction coil 52. This allows the magnetic flux to increase and thus leads to an increase in the induced power.

In the example shown in FIG. 5B, the induction coil 52 is arranged in a receptacle 55 within the side plate 3. The receptacle 55 is prefabricated with the side plate 3, which is preferably injection-molded from plastic and thus forms an electrically insulating receptacle 55. In contrast to FIG. 5A, the excitation magnets 51 in FIG. 5B are oriented with their pole directions or main magnetic flux radially with respect to the axis of rotation of the track roller 53. Preferably, an even number of excitation magnets 51, here for example six excitation magnets 51 each at 60° angular spacing, are provided circumferentially equally distributed and with poles alternating towards the induction winding 52. FIG. 5B also shows only one induction coil 52, wherein several induction coils 52, however, may also be provided adjacently to the circumference of the carrying wheel. The assembly of the arrangement shown in FIG. 5B does not require any appreciable volume within the receiving space 7 and permits retrofitting of roller chains which are known per se.

Instead of equipping or retrofitting a roller chain with track rollers 53 by means of one or more rotary generators 50, it is also conceivable to selectively equip a chain which in essence is a sliding chain with one or more chain links 2, with track rollers 53 and rotary generator 50 in order to generate electrical energy from the movement of the upper strand 11.

FIG. 6 shows another embodiment of an energy chain 1 with energy converters in the form of solar cells 63 attached to the outer sides of the chain links 2. A plurality of solar cells 63 are attached at different positions at the outer side of the chain links 2, i.e. radially outwards with respect to the deflection arc 15. The solar cells 63 generate power as long as they are exposed to at least one light source. Solar cells 63 can be provided in addition to an electromechanical generator, for example a vibration energy converter according to FIG. 3A-3B, in order to charge any energy store that may be present even when the energy chain 11 is still, if, for example, the sensor module 10 is to be able to transmit information even in the idle state.

### LIST OF REFERENCE SIGNS

### FIG. 1A-1D

1 energy chain
2 chain link
3 side plate
4 permanent magnet
5A, 5B end fastenings
6 crossbar
7 receiving space
8 induction coil
9 conversion unit
10 sensor module
11 upper strand/movable strand
12 lower strand/still strand
14 energy converter (vibration energy converter)
15 deflection arc
16 guide channel
17 auxiliary module
18 energy converter
21 magnetic holder

### FIG. 3A-3B

30 crossbar receptacle
31 induction coil
32 bar magnet
33 spiral spring
34 holding point
35 guide

### FIG. 4

40 piezo element
41 first chain link
42 second chain link
43 pivot bearing
44 stop
45 upper stop surface
46 lower stop surface

### FIG. 5A-5B

3 side plate
50 energy converter (rotary generator)
51 permanent magnet
52 induction coil
53 track rollers
54 inner surface
55 receptacle

### FIG. 6

1 energy chain
11 movable strand
12 still strand
15 deflection arc
63 solar cell

What is claimed is:

1-18. (canceled)

19. An energy chain for guiding lines, such as cables, hoses or the like, between two connection points, at least one of which is movable relative to the other, the energy chain comprising:
chain links which are connected to each other and pivotable with respect to each other, wherein the energy chain is movable in particular with a first strand relative to a second strand while forming a deflection arc between the strands; and
at least one load consuming electrical energy, which is arranged at or in the energy chain, in particular at least one sensor module at a chain link for detecting an operating parameter of the energy chain; wherein
the energy chain includes at least one energy converter which is designed as an electromechanical generator to convert kinetic energy of the energy chain into electrical energy when the movable first strand of the energy chain and/or the deflection arc of the energy chain is moved, and which is connected or connectable to the load in order to supply the latter.

20. The energy chain according to claim 19, wherein the at least one energy converter comprises an induction coil for generating power by electromagnetic induction.

21. The energy chain according to claim 19, wherein the energy chain includes at least one sensor module for detecting an operating parameter of the energy chain, in particular a sensor module cooperating wirelessly with a monitoring system, and in that the at least one sensor module is supplied with electrical energy by the energy converter.

22. The energy chain according to claim 19, wherein the energy chain is designed as a roller chain with track rollers, wherein the energy converter is designed in the form of a rotary generator and is arranged at an associated track roller in order to generate electrical energy from the rotary movement of the track roller.

23. The energy chain according to claim 22, wherein the track roller comprises at least one permanent magnet and the roller chain link includes at least one induction coil, which is preferably accommodated in a prefabricated receptacle in a side plate of the chain link.

24. The energy chain according to claim 20, wherein:
an electrical generator with a number of magnets is provided as an energy converter, which magnets cooperate with an induction coil of the energy converter during the movement for converting kinetic energy of the energy chain into electrical energy,
wherein preferably the magnets form a linear generator with the induction coil and:
a number of permanent magnets are provided at least at a longitudinal portion of the energy chain; and/or
a number of permanent magnets and/or electromagnets are provided at a holder arranged laterally to the energy chain.

25. The energy chain according to claim 24, wherein each of the permanent magnets is provided at a separate crossbar or separating bar of a chain link of the energy chain, preferably at the outer side of a crossbar facing the other strand and/or at a detachably fastened crossbar.

26. The energy chain according to claim 19, wherein the at least one energy converter is designed as a vibration energy converter and is attached in particular in or to the driver-side longitudinal half of the energy chain.

27. The energy chain according to claim 26, wherein the vibration energy converter comprises at least one induction coil, at least one bearing unit, in particular comprising at least one spring element, for supporting the induction coil and at least one permanent magnet, so that a variable magnetic field is generated within the induction coil by reciprocating movement of the energy chain and a voltage is induced in the induction coil, wherein the permanent magnet is preferably mounted movably in a tubular guide.

28. The energy chain according to claim 19, wherein an electrical energy storage unit, in particular an accumulator or capacitor storage unit, is provided at the energy chain in order to store power generated discontinuously by the energy converter for supplying the load or a load as required.

29. The energy chain according to claim 19, wherein a sensor module for detecting an operating parameter of the energy chain is provided, which sensor module is connected to the energy converter for power supply and/or into which the energy converter for power supply is integrated, wherein the sensor module preferably comprises the energy storage unit.

30. The energy chain according to claim 29, wherein the sensor module is supplied exclusively by the one or more energy converters and cooperates wirelessly with a monitoring system and/or wirelessly with a portable terminal, wherein the sensor module preferably comprises at least an acceleration sensor, a temperature sensor and a radio data transmission unit.

31. The energy chain according to claim 19, wherein:
the chain links define a receiving space for the lines and the energy converter is provided laterally at the receiving space, in particular at or in a side plate, a crossbar or a separating bar of the chain link; and/or
a plurality of chain links with a corresponding energy converter are provided; and/or
the chain links are connected to each other in an articulated manner, in particular pivotably in a plane relative to each other to form a deflection arc.

32. A chain link for an energy chain according to claim 19 for guiding lines, such as cables, hoses or the like, between two connection points, at least one of which is movable relative to the other, wherein the chain link defines a receiving space for the lines, wherein:
the chain link includes an energy converter which is designed as an electromechanical generator to convert kinetic energy of the energy chain into electrical energy when the energy chain is moved and to provide electrical energy for supplying a consumer at or in the energy chain; and
the energy converter comprises an induction coil for generating power by electromagnetic induction.

33. The chain link for the energy chain according to claim 32, wherein the chain link is designed as a roller chain link and includes at least one track roller, wherein
the energy converter is designed in the form of a rotary generator and is arranged on the track roller in order to generate electrical energy from the rotary movement of the track roller.

34. The chain link according to claim 32, wherein:
the track roller comprises a plurality of circumferentially distributed permanent magnets; and/or
the track roller comprises at least one permanent magnet and the induction coil is accommodated in a prefabricated receptacle in a side plate of the chain link; and/or
the energy converter is provided laterally at the receiving space, in particular at or in a side plate, a crossbar or a separating bar of the chain link.
